(19) United States
(12) Patent Application Publication
(10) Pub. No.: US 2013/0263053 A1
(43) Pub. Date: Oct. 3, 2013

(54) MEDIA WIDGET TO INTERFACE WITH MULTIPLE UNDERLYING APPLICATIONS

(71) Applicants: Charles G. Tritschler, Los Altos, CA (US); Evance C. Mok, Palo Alto, CA (US); Santhosh Kumar P. Krishnankutty, Dublin, CA (US); Aaron M. Bromberg, Mountain View, CA (US)

(72) Inventors: Charles G. Tritschler, Los Altos, CA (US); Evance C. Mok, Palo Alto, CA (US); Santhosh Kumar P. Krishnankutty, Dublin, CA (US); Aaron M. Bromberg, Mountain View, CA (US)

(21) Appl. No.: 13/434,374

(22) Filed: Mar. 29, 2012

(51) Int. Cl. G06F 9/46; G06F 3/048

(52) U.S. Cl. 715/835; 719/313

(57) ABSTRACT

A media widget running on a user device includes a widget content synchronization module, which includes a plurality of application adapters. Each of the plurality of application adapters interfaces with a different one of a plurality of underlying media applications configured to provide media content. The media widget also includes a widget content storage module to store, in a memory, widget content received by the plurality of application adapters from the plurality of underlying media applications, wherein the widget content corresponds to the media content. The media widget further includes a widget content delivery module to provide a user interface to display the widget content stored in the memory from the plurality of underlying media applications.

### BACKGROUND OF THE INVENTION

A large and growing population of users enjoys entertainment through the consumption of media items, including electronic media, such as electronic books (also referred to herein as ebooks), electronic newspapers, electronic magazines, digital audio and digital video. Users employ various electronic devices to consume such media items. Among these electronic devices are electronic book readers, cellular telephones, smartphones, personal digital assistants (PDAs), portable media players, tablet computers, netbooks, desktop computers, notebook computers, and the like.

Many electronic devices may include certain applications designed specifically for consuming different types of media. For example, an electronic device may include an electronic reader (e-reader) application for reading electronic publications, an audio application for listening to digital audio files, a video application for viewing digital video files, etc. Fully launching each of these different applications may be a time consuming and memory intensive process. This problem is especially acute on mobile computing devices, where memory space may be at a premium. If a user wishes to only briefly access media content from one of these applications (e.g., view a list of available movie titles in the video application, but not actually watch any of them), fully launching the video application may be a waste of resources.

As an alternative to fully launching an application, many application developers have developed widgets for their corresponding applications. Widgets generally are software applications designed to run in the main desktop or home screen of an electronic device that have a light user interface, meaning that they are relatively simple and easy to use. This is in contrast to the full application which may offer considerably more features and functionality than the widget. A widget may be provided with data from the underlying application, which is presented to the user through the widget interface. In addition, the widget may be able to receive user input and provide information back to the underlying application.

### BRIEF DESCRIPTION OF THE DRAWINGS

The present invention will be understood more fully from the detailed description given below and from the accompanying drawings of various embodiments of the present invention, which, however, should not be taken to limit the present invention to the specific embodiments, but are for explanation and understanding only.

FIG. 1 is a block diagram of an exemplary network architecture, in which embodiments of the present invention may operate.

FIG. 2 is a block diagram illustrating a user device implementing a media widget to interface with multiple underlying applications, according to an embodiment.

FIG. 3A is a flow diagram illustrating a media widget interface method, according to an embodiment.

FIG. 3B is a diagram illustrating a media widget user interface, according to an embodiment.

FIG. 3C is a diagram illustrating a media widget user interface, according to an embodiment.

FIG. 4 is a flow diagram illustrating a media widget interface and content synchronization method, according to an embodiment.

FIG. 5 is a flow diagram illustrating a user interaction method for a media widget, according to an embodiment.

FIG. 6 is a block diagram illustrating one embodiment of a computer system, according to an embodiment.

FIG. 7 is a block diagram illustrating an exemplary user device, according to an embodiment.

### DETAILED DESCRIPTION OF THE PRESENT INVENTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Embodiments of a method and apparatus are described for a media widget to interface with multiple underlying media applications. In one embodiment, the media widget may provide a unified dashboard view of multiple available media applications installed on a user device. The media widget may be easily installed on a user device produced by any manufacturer to provide access to media content managed by the underlying media applications to improve the experience of the user. In one embodiment, the media widget includes a media widget view interface (e.g., a user interface) provided on a home screen of an operating system of the user device or in conjunction with the display of the home screen. The media widget may provide users with fresh and relevant content from the multiple underlying media applications in a single interface and allow users to quickly and easily interact with that media content. The data provided by the widget may be referred to as widget content and may include data, metadata, or other information corresponding to the media content. For example if the media content provided by an application includes a variety of videos, the widget content may include a list of available videos, recently watched videos or recommended videos, rather than the actual videos themselves. In one embodiment, the received widget content may be a portion or subset of the media content or data (e.g., screenshots, video clips, audio samples), metadata or information corresponding to the media content, rather than the entire media content itself. Media widget process 210 may receive additional data as well, such as images associated with the media content (e.g., album art, book covers, movie posters, etc.) or other additional data. In addition, the widget content may include data or metadata about the media content available from each of the underlying media applications. This data or metadata may include, for example, a list of popular audio files, recently played audio files, or favorite audio files from an audio application, or a list of recently downloaded applications or recommended available applications from an app store application. Furthermore, the widget content may include additional information that is not directly related to the media content, such as information about the connected underlying media applications (e.g., which applications are available, which applications have been activated, which applications have updated content, etc.). The multiple underlying media applications may include, for example, an audio application, a video application, a mobile application store, a shopping application, an electronic reader application, or other media applications.

In one embodiment, the media widget view interface is supported by a software backend media widget process. The media widget process may include a widget content synchronization module, which includes multiple application adapters. Each of the application adapters may interface with a different one of the underlying media applications. The media widget process may also include a widget content storage module to store, in a memory, widget content received by the application adapters from the underlying media applications. The widget content may include, for example, a list of recently played audio files from the audio application or a list of recommended mobile applications from the app store application. Caching the widget content in a local data store or memory may save the time and expense of fully launching the underlying application each time the widget content is presented in the widget interface. The media widget process may further include a widget content delivery module to provide the user interface to display the widget content stored in the memory.

In one embodiment, the widget content synchronization module may periodically receive an indication of updated widget content from one of the plurality of underlying media applications. For example, if new recommended mobile applications become available in the app store application, the app store application may send a message to the media widget process. The widget content synchronization module may synchronize the updated widget content and the widget content stored in the memory. This may include saving the updated widget content in the memory and discarding the previous widget content.

The media widget described herein provides users access to media content from multiple underlying media applications in a single easy to use widget interface. The single interface may save display area space in the home screen of the user device that might normally be taken up by individual widgets for each of the underlying media applications. In addition, the media widget preserves valuable memory space by temporarily caching or saving the widget content rather than fully launching the underlying applications each time the widget content is displayed. The media widget may also have configurable synchronization schedules for each of the media applications to ensure that the most recent widget content is available while still making efficient use of system resources (e.g., memory space, battery life, network bandwidth, etc.).

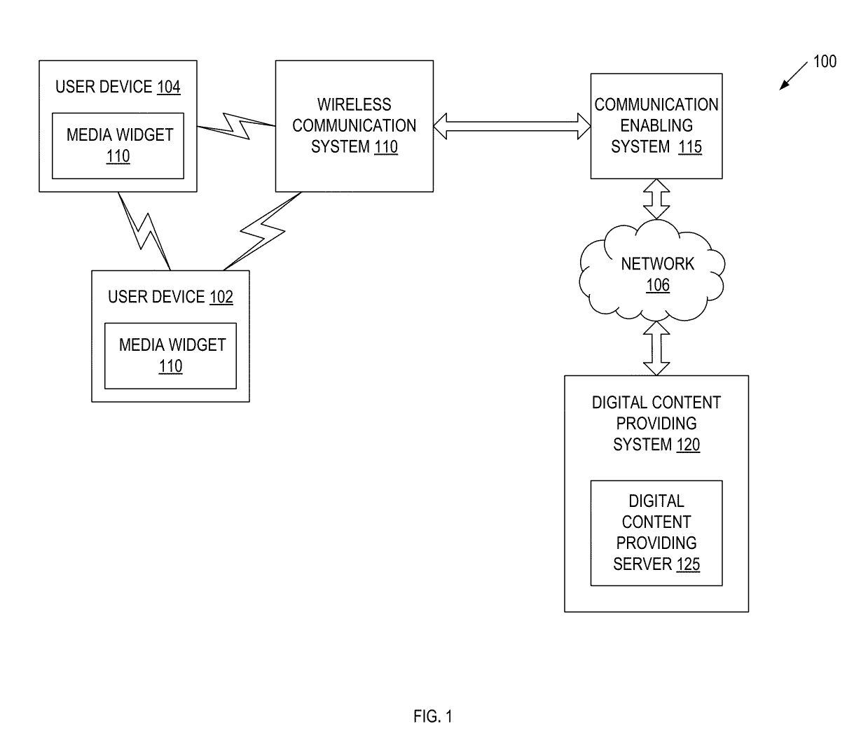

FIG. 1 is a block diagram of an exemplary network architecture 100, in which embodiments of the present invention described herein may operate. The network architecture 100 may include a digital content providing system 120 and one or more user devices 102, 104 capable of communicating with the digital content providing system 120 via a network 106. Network 106 may include, for example, a public network such as the Internet or a private network such as a local area network (LAN).

The user devices 102, 104 may be portable computing devices such as electronic book readers or tablet computers (e.g., that include a book reader application). Other examples of portable computing devices include cellular telephones, personal digital assistants (PDAs), portable media players, netbooks, and the like. The user devices 102, 104 may also be non-portable computing devices such as a desktop computer, a set-top box associated with a television, a gaming console, and so on. The user devices 102, 104 are variously configured with different features to enable consumption of one or more types of digital content and electronic media items. The digital content and electronic media items may include electronic books (ebooks) such as electronic textbooks and/or other electronic publications (electronic versions of publications) such as electronic magazines, digital newspapers, digital audio books, electronic journals, real simple syndication (RSS) feeds, etc. The media items may also include digital video (e.g., movies, television, short clips, etc.), images (e.g., art, photographs, etc.), audio files, and multi-media content.

The digital content providing system 120 may correspond to any feature or combination of features for providing electronic media items or other digital content to the user devices 102, 104. The digital content providing system 120 may include a network-accessible server-based functionality (digital content providing server 125), various data stores (not shown), and/or other data processing equipment. The digital content providing system 120 may be implemented by a single machine or a cluster of machines. The digital content providing system 120 may include one or more machines (e.g., one or more server computer systems, routers, gateways, etc.) that have processing and storage capabilities to provide the server-based functionality.

In one embodiment, the digital content providing server 125 corresponds to an entity which provides electronic publications (e.g., electronic books) to users upon the users' purchase of the items. In this role, the digital content providing server 125 may essentially act as a bookseller or the like. In other cases, the digital content providing server 125 corresponds to an entity which provides electronic publications to users on a non-fee basis or on the basis of some other type of alternative compensation arrangement. Thus, the term a “provider” of items should be construed broadly to encompass educational institutions, governmental organizations, libraries, non-profit organizations, retailers, auction services, and so on, or some cooperative combination of any two or more entities.

The digital content providing server 125 may deliver, and the user devices 102, 104 receive, electronic publications (or other media items), search results, upgrades, and/or other information via the network 106. For example, the user devices 102, 104 may download or receive ebooks from the digital content providing server 125. The digital content providing server 125 may also receive various requests (e.g., search queries), instructions and other data from the user devices 102, 104 via the network 106.

Communication between the user devices 102, 104 and the item providing system 120 may be enabled via any communication infrastructure. One example of such an infrastructure includes a combination of a wide area network (WAN) and wireless infrastructure, which allows a user to use the user devices 102, 104 to purchase digital content (e.g., electronic publications) and consume the digital content without being tethered to the digital content providing system 120 via hardwired links. The wireless infrastructure may be provided by one or multiple wireless communications systems, such as wireless communication system 110. In one embodiment, wireless communication system 110 may be a wireless fidelity (WiFi) hotspot connected with the network 106. Wireless communication system 110 may also be a wireless carrier system that can be implemented using various data processing equipment, communication towers, etc. Alternatively, or in addition, the wireless carrier system may rely on satellite technology to exchange information with the user devices 102, 104.

The communication infrastructure may also include a communication-enabling system 115 that serves as an intermediary in passing information between the digital content providing system 120 and the wireless communication system 110. The communication-enabling system 115 may communicate with the wireless communication system 110 (e.g., a wireless carrier) via a dedicated channel, and may communicate with the digital content providing system 120 via a non-dedicated communication mechanism, (e.g., a public Wide Area Network (WAN) such as the Internet).

In addition to wirelessly connecting to wireless communication system 110, user devices 102, 104 may also wirelessly connect to other user devices 102, 104. For example, user device 102 may form a wireless ad hoc (peer-to-peer) network with user device 104 using WiFi, Bluetooth, or other wireless communication protocols.

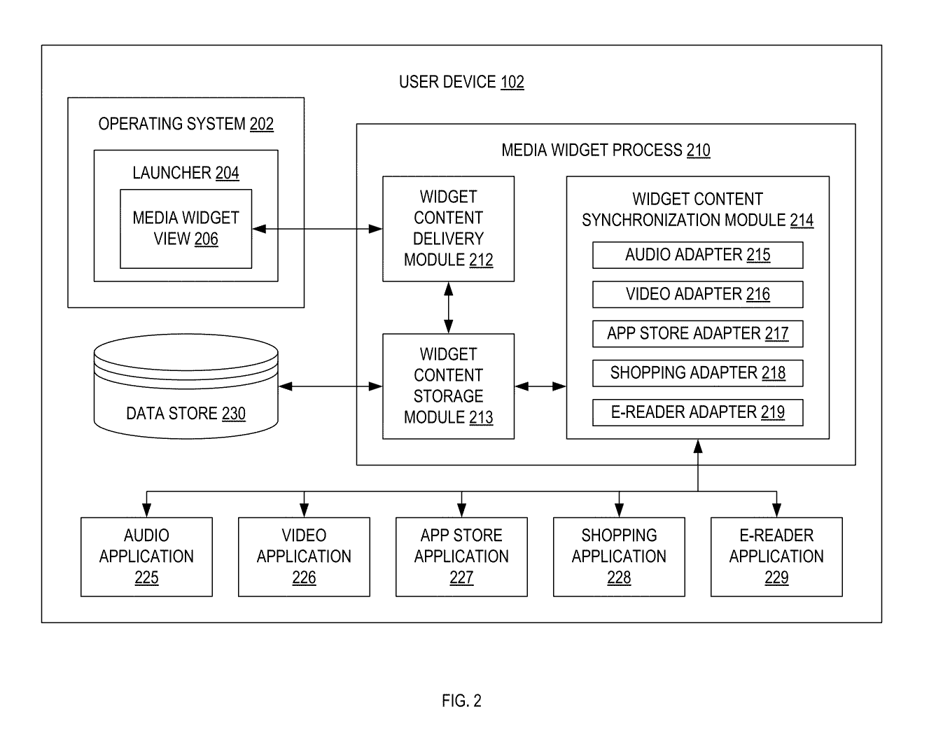

In one embodiment, either or each of user devices 102 and 104, may run a media widget 110 configured to interface with multiple underlying media applications. Media widget 110 may be a software application designed to run in a main desktop or home screen of user devices 102 and 104 or to be displayed in conjunction with the display of the home screen. In other embodiment, media widget 110 may include an application, a desk accessory, an applet, a gadget, or some other type of software application. As is described in detail below, media widget 110 may include a light user interface (i.e., relatively simple and easy to use) and a software backend. The backend of media widget 110 may be designed to receive widget content from multiple underlying applications running on user device 102 or 104 and temporarily store or cache the received widget content. In one embodiment, the widget content may be received by the media applications on user devices 102 and 104 from digital content providing server 125. Media widget 110 may present this widget content to the user in a user interface, which may be shown on an internal or external display of user device 102 or 104. In one embodiment, the user interface of media widget 110 may be relatively simpler and easier to use compared, for example, to the full underlying application, which may offer considerably more features and functionality than media widget 110. In one embodiment, the backend of media widget 110 may receive updates to the widget content from the multiple underlying applications and may synchronize the stored content with this updated widget content. In addition, media widget 110 may be able to receive user input and provide information back to the underlying applications. In one embodiment, media widget 110 may actually be a “multimedia” widget, in that it can support a variety of media types. For example, a multimedia widget (e.g., media widget 110) may provide simultaneous or sequential access to audio media items, video media items, electronic publications, online web content, or items of other media types. Depending on the embodiment, the underlying applications may provide one type of widget content or multiple different types of widget content, all of which can be supported by media widget 110. Additional details of media widget 110 are provided below with respect to FIGS. 2-5.

FIG. 2 is a block diagram illustrating a user device 102 implementing a media widget 110 to interface with multiple underlying applications, according to an embodiment of the present invention. In one embodiment, user device 102 includes an operating system 202, media widget process 210, and multiple media applications 225-229. Media widget process 210 may interface with media applications 225-229 to receive widget content, and may present some or all of that widget content to a user through a media widget view interface 206. Media widget view interface 206 may be a user interface displayed as part of the operating system 202 of user device 102. Together, media widget process 210 and media widget view interface 206 may be one representation of media widget 110, as shown in FIG. 1.

Operating system 202 may include a set of programs that manage hardware resources of user device 102 and provide common services for applications, such as applications 225-229, running on user device 102. In one embodiment, operating system 202 may include a kernel to control low-level processes, such as how memory is read and written, the order in which processes are executed, how information is received and sent by user device 102, to control any peripheral devices, such as monitor, keyboard, mouse, touch screen, etc. and how to interpret information received over networks. Operating system 202 may additionally include a user interface to interact with a user of user device 102, allowing them to control and use applications 225-229. In one embodiment, the user interface may be graphical with icons and a desktop or home screen, such as launcher 204, which may be accessed by the user, for example, using a touch screen display. In one embodiment, the media widget view interface 206 may be displayed as part of launcher 204. In addition, operating system 202 may include application programming interfaces (APIs) to provide services and code libraries that let application developers write modular code reusing well defined programming sequences in user space libraries or in the operating system 202 itself. In one embodiment, where user device 102 is a mobile computing device, such as a tablet, the operating system 202 may be the ANDROID™ operating system from Google Inc. of Mountain View, Calif. In other embodiments, operating system 202 may be some other mobile or non-mobile operating system, such as iOS from Apple Inc., or Windows Phone from Microsoft.

The applications on user device 102, such as media applications 225-229, may be designed to manage and play various types of media content. The applications 225-229 may provide functionalities for the media content including, but not limited to, purchasing, downloading, managing, saving, recording, and/or playing the media content. For ease of explanation, these actions may be summarized as managing the media content in the description that follows. In one embodiment, media applications 225-229 may be a suite of related applications available as a package or bundle, or may be individually available from a single developer. In another embodiment, media applications 225-229 may not be related and/or may be provided by different application developers. However, each of applications 225-229 may include a provider process to deliver widget content managed by the applications to a requestor (e.g., media widget process 210). In one embodiment, these providers may be designed to receive a request (e.g., a specific uniform resource identifier (URI)) and return certain widget content. Examples of the widget content that may be returned by the applications 225-229 are provided below. In one embodiment, the applications 225-229 are embodied on a storage device within user device 102. In one embodiment, at least one of the applications 225-229 is stored in memory (e.g., data store 230). In another embodiment, one or more of applications 225-229 are not resident on user device 102, but are accessible by user device 102 over a network (e.g., network 106).

In one embodiment, user device 102 may include audio application 225, which may be a program designed to manage various audio files, such as MP3 files, WAV files, or other audio file types. Video application 226 may be a program designed to manage various video files, such as MPEG, 3GP, or other video file types. Mobile application store (app store application) 227 may be a store or marketplace designed to allow users to purchase and/or download other applications or programs for use on user device 102. In one embodiment, app store application 227 may be a gateway to an online store where users may browse and purchase the applications and download them onto user device 102. Shopping application 228 may be a program designed to allow users to view product details, read reviews, check prices, and/or purchase various consumer goods, such as books, music CDs, DVDs, consumer electronics, tools, toys, clothing, sporting goods, jewelry, beauty products, musical instruments or other goods. The goods available through shopping application 228 may be tangible items that may be delivered to the user, as opposed to software applications available through app store application 227 which may be electronically delivered to the user device 102 over a network, such as network 106. E-reader application 229 may be a program designed to manage various electronic publications, such as electronic books (ebooks), electronic magazines, electronic newspapers or other electronic publications. E-reader application 229 may allow a user to purchase and/or download electronic publications and/or read or view them on a display of user device 102. The types of applications described above are merely examples of the types of applications which user device 102 may include, and it should be understood that in other embodiments, user device 102 may include additional, fewer, and/or different media applications than those described above.

Media widget process 210 may be one example of the software backend portion of media widget 110 discussed above with respect to FIG. 1. In one embodiment, media widget process 210 includes widget content delivery module 212, widget content storage module 213 and widget content synchronization module 214. Together, modules 212-214 may receive widget content from applications 225-229, temporarily store or cache that content (e.g., in data store 230), receive updates to the widget content, synchronize the stored media with the updated content and provide the widget content to media widget view interface 206.

In one embodiment, widget content delivery module 212 may include one or more services to present widget content to media widget view interface 206 and communicate user interaction data from media widget view interface 206 to media widget process 210. For example, in an embodiment where operating system 202 is the ANDROID™ operating system, widget content delivery module may include the AppWidgetProvider class and the RemoteViewsService service. Widget content delivery module 212 may be responsible for delivering the widget content to media widget view interface 206 and for responding to update requests received from the user through interface 206 and/or from the underlying applications 225-229 received through widget synchronization module 214. For example, if a user requests updated widget content through media widget view interface 206, the widget content delivery module 212 may receive an update method call. In response, widget content delivery module 212 may query widget content storage module 213 for any updated widget content. If updated widget content is identified in response to the query, widget content delivery module 212 may publish that updated data as one or more view objects in media widget view interface 206. The classes and services of widget content delivery module 212 may be part of a widget framework used by operating system 202. By using services from this framework, media widget process 210 may be easily ported to user devices from a variety of manufacturers, as long as they support the widget framework.

In one embodiment, widget content storage module 213 may include one or more services to temporarily store or cache widget content before it is presented to media widget view interface 206 by widget content delivery module 212. Widget content storage module 213 may store the widget content, for example, in data store 230. In one embodiment, data store 230 may be a file system, database or other data management layer resident on a data storage device such as a disk drive, RAM, ROM, etc. In one embodiment, widget content storage module 213 may include a storage interface, an application state manager and an asset manager.

The storage interface may handle communications between media widget process 210 and data store 230. The storage interface may process requests from widget content delivery module 212 to read data and widget content from data store 230 and requests from widget content synchronization module 214 to write data and widget content to data store 230.

The application state manager may monitor the state of applications 225-229. In one embodiment, the state manager may maintain state information in data store 230 for individual underlying applications 225-229, as well as for media widget process 210. The state manager may abstract the authentication state for a user of user device 102, as well as any individual states of the applications 225-229. For example, the user may be logged in to the media widget, using for example, a single sign-on (SSO) solution, and audio application 225 may already be installed on user device 102. If audio application 225 is not registered with media widget process 210, however, no data will be accessible. The state manager in widget content storage module 213 may query this state information from audio application 225 and invoke any needed functionality (e.g., registration) in the audio application 225 to ensure that the application is in a state where media widget process 210 can query content successfully.

In one embodiment, the asset manager may manage the widget content and other assets that will be used by the widget. This may include the caching of bitmap sources or decoded bitmaps for images in data store 230, as needed to maintain a high level of performance for the widget. The asset manager may retrieve assets both locally from the providers of applications 225-229 and/or from remote data sources (e.g., over network 106). For example, video application 226 may present one or more images representing available videos to media widget process 210. When a user launches the widget, those images may be displayed in media widget view 206. Rather than having to fully launch video application 226 each time these images are needed, the asset manager and storage interface of widget content storage module 213 may simply use the temporarily stored copies of these images from data store 230. This may save time and resources (e.g., memory space) that would be used in fully launching video application 226.

In one embodiment, widget content synchronization module 214 may handle data retrieval and synchronization of widget content from the providers in media applications 225-229. Widget content synchronization module 214 may normalize the data for media widget process 210 and provide it to the storage interface of widget content storage module 213 for storage in data store 230. In one embodiment, the received widget content includes various pieces of generic data. For each application 225-229, and possibly each query, widget content synchronization module 214 may have a data mapping which associates the generic data with a set of data fields. The data mapping may include a base set of fields that are shared by all applications as well as an extended set of fields that are specific to individual applications. Widget content synchronization module 214 may convert the received generic data to field specific data, which may be used by widget content storage module 213 to store the widget content and widget content delivery module 212 to render the widget content in media widget view 206. In certain embodiments, widget content synchronization module 214 may retrieve widget content from applications 225 through scheduled polling and/or through update notifications from the underlying media applications 225-229. For example, media widget process 210 may query the providers of application 225-229 for updated widget content periodically or according to some other schedule (e.g., when user device 102 is started, when media widget 110 is launched, etc.), or applications 225-229 may provide a notification of updated widget content each time that updated content becomes available. For example, if a new e-book is downloaded and made available for reading in e-reader application 229, the provider of e-reader application 229 may provide a notification to widget content synchronization module 214. In another embodiment, a user may be able to request that media widget process 210 query media applications 225 for updated widget content by issuing an update command through media widget view interface 206.

In one embodiment, widget content synchronization module 214 may include multiple application adapters, each corresponding to a different one of underlying media applications 225-229. For example, audio adapter 215 may correspond to audio application 225, video adapter 216 may correspond to video application 226, app store adapter 217 may correspond to app store application 227, shopping adapter 218 may correspond to shopping application 228, and e-reader adapter 219 may correspond to e-reader application 229. The adapters 215-219 may bind the interface presented in media widget view interface 206 to the widget content from the corresponding one of underlying media applications 225-229. The adapters 215-219 may bind individual items from the widget content of applications 225-229 into individual view objects that may be stored by widget content storage module 213 and displayed in media widget view interface 206.

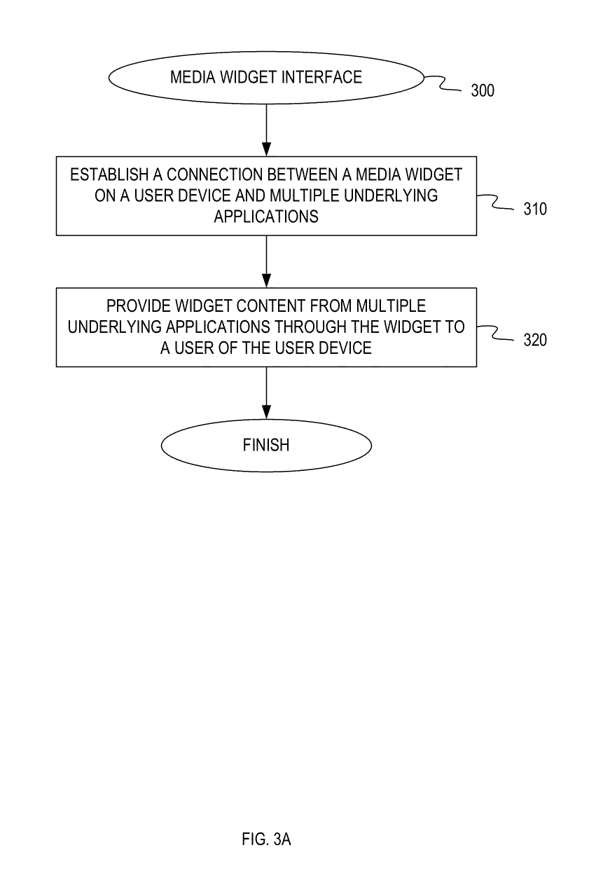

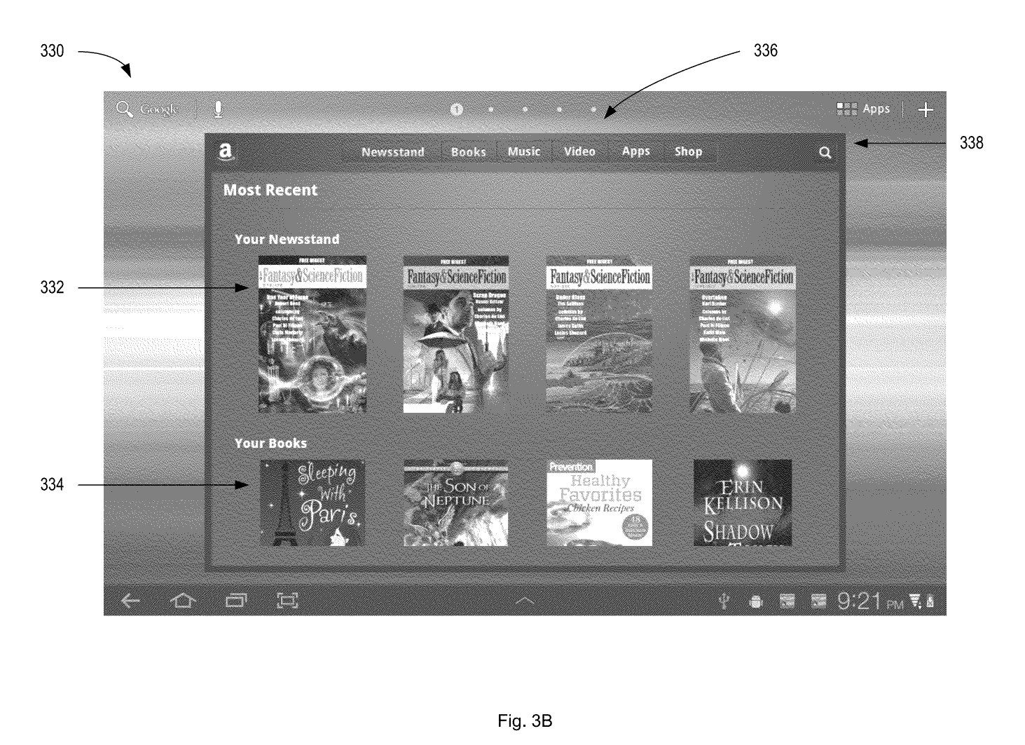

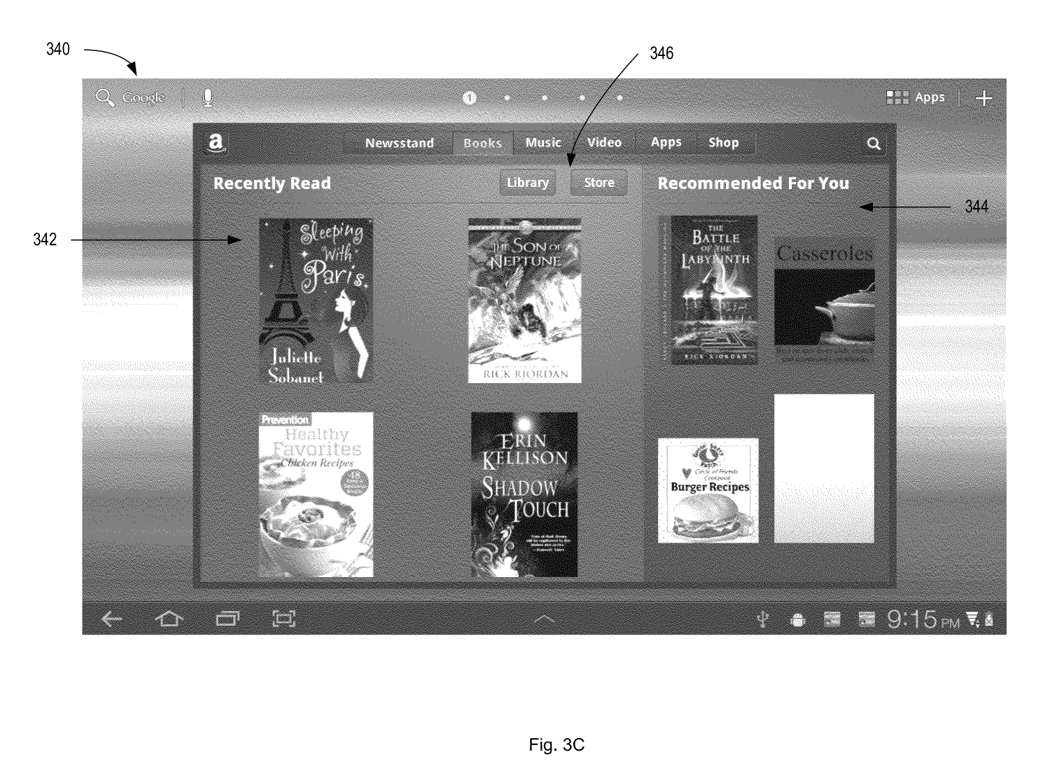

FIG. 3A is a flow diagram illustrating a media widget interface method, according to an embodiment of the present invention. The method 300 may be performed by processing logic that comprises hardware (e.g., circuitry, dedicated logic, programmable logic, microcode, etc.), software, firmware, or a combination thereof. The processing logic is configured to provide a media widget that combines widget content from multiple underlying applications. In one embodiment, method 300 may be performed by media widget process 210, as shown in FIG. 2.

Referring to FIG. 3A, at block 310, method 300 establishes an operational connection between a media widget 110 on a user device 102 and multiple underlying media applications. In one embodiment, the operational connection may include a logical connection that allows the media widget 110 to interface with the multiple media applications 225-229. In one embodiment, the media widget 110 may include media widget view interface 206 and media widget process 210. Media widget view interface 206 may include a user interface for the widget 110 that is displayed in a home screen or launcher 204 of an operating system 202 running on user device 102 or displayed in conjunction with the display of the home screen (e.g., on top of the home screen, within the home screen, adjacent to the home screen, etc.). In exemplary scenarios, media widget view interface 206 may occupy more display area space on a display of user device 102 than a conventional icon would, and in one embodiment, may occupy a majority of the real estate in the home screen or launcher. Media widget 110 may provide the functionality to allow a user to interface with multiple underlying media applications 225-229. Interfacing with the underlying media applications 225-229 may include, for example, receiving widget content from the applications 225-229, receiving updates from the applications 225-229, sending requests for widget content to the applications 225-229, or other functions. These applications may include, for example, audio application 225, video application 226, app store application 227, shopping application 228, e-reader application 229 and/or other applications.

At block 320, method 300 provides widget content from multiple underlying applications 225-229 to a user of user device 102. Media widget process 210 may receive widget content from the underlying applications 225-229. In one embodiment, the received widget content may be a portion or subset of the media content or data, metadata or information corresponding to the media content, rather than the entire media content itself. For example, media widget process 210 may receive a list of popular audio files, recently played audio files, or favorite audio files, rather than a list of all audio files or the audio files themselves, from audio application 225. Similarly, media widget process 210 may receive a list of recently downloaded applications or recommended available applications from app store application 227, rather than a list of all available applications. Media widget process 210 may receive additional data as well, such as images associated with the media content (e.g., album art, book covers, movie posters, etc.) or other additional data. Widget 110 may present this widget content to the user through media widget view interface 206. Media widget view interface 206 may present the widget content received from each of the underlying media applications in a unified interface. For example, media widget view interface 206 may display the list of recently played audio files from audio application 225 (and optionally any associated album art) as well as the list of recommended available applications from app store application 227. Media widget view interface 206 may similarly display widget content from the other underlying applications as well.

FIGS. 3B and 3C are diagrams illustrating media widget view interfaces, according to embodiments of the present invention. The interfaces 330 and 340 may be representative of a user interface, such as media widget view 206 provided by widget content delivery module 212. In one embodiment, interface 330 provides widget content including a list of recently viewed media items, such as newsstand periodicals 332 and e-books 334. As discussed above, the widget content may be a limited subset of all media items available from one of underlying applications 225-229. In one embodiment, interface 330 also includes navigation controls 336, which may allow a user to view widget content in other categories, including for example, newsstand, books, music, video, apps, and shopping. A search control 338 may also allow the user to search the widget content for a specific media item. Interface 340, shown in FIG. 3C, illustrates another embodiment of the interface. Interface 340 may display a view of books category, which may include electronic publications provided, for example, by e-reader application 229. In this embodiment, the interface 340 is divided into two sections 342 and 344, each displaying separate widget content. Section 342 may display widget content representing recently read publications and section 344 may display widget content representing recommended publications. Interface 340 may also include additional controls 346, which may allow the user to view additional widget content or shop for new media items (e.g., in an on-line store). It should be understood that interfaces 330 and 340 are merely examples of the user interfaces that may be provided by media widget 110, and that in other embodiments, the interfaces may include additional or different widget content and/or provide additional or different features or functionality.

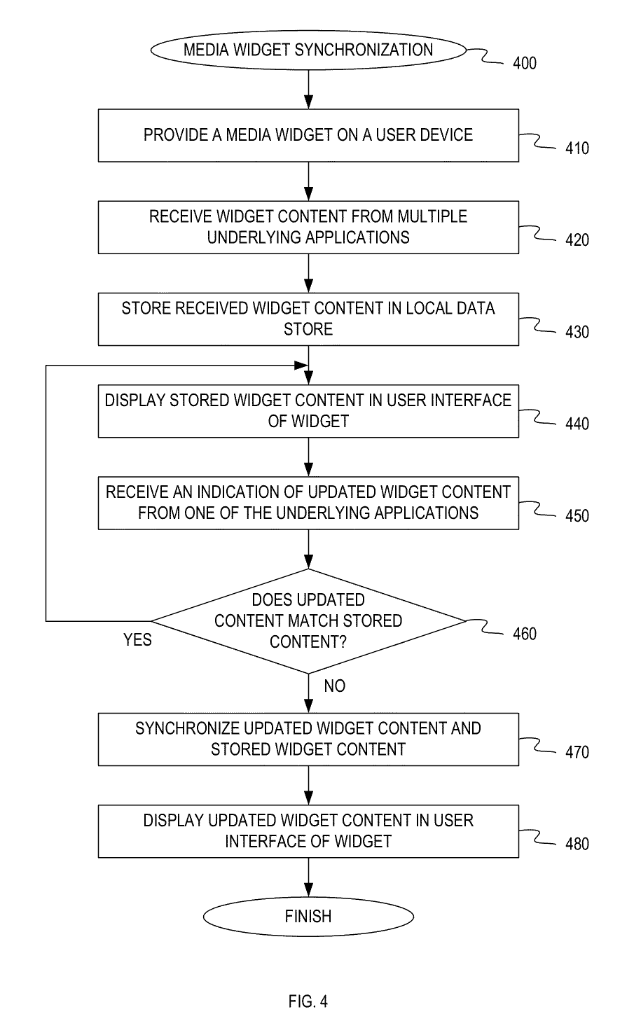

FIG. 4 is a flow diagram illustrating a media widget interface and content synchronization method, according to an embodiment of the present invention. The method 400 may be performed by processing logic that comprises hardware (e.g., circuitry, dedicated logic, programmable logic, microcode, etc.), software, firmware, or a combination thereof. The processing logic is configured to provide a media widget that interfaces with and synchronizes widget content from multiple underlying applications.

In one embodiment, method 400 may be performed by media widget process 210, as shown in FIG. 2.

Referring to FIG. 4, at block 410, method 400 provides a media widget 110 on a user device 102. In one embodiment, the media widget may include media widget view interface 206 and media widget process 210. At block 420, method 400 receives widget content from multiple underlying media applications 225-229. In one embodiment, when user device 102 is started, or when media widget 110 is launched, media widget process 210 may receive the widget content. The adapters 215-219 of widget content synchronization module 214 may be preconfigured to query the underlying applications 225-229 for certain widget content. In one embodiment, each of the adapters 215-219 may provide a URI to a provider of the corresponding application 225-229. In response to receiving the URI, the provider of each of applications 225-229 may return a certain piece or pieces of widget content. In certain embodiments, the widget content that is returned may be configurable by the widget 110 or by the user. For example, media widget process 210 may receive a list of popular audio files, recently played audio files, or favorite audio files from audio application 225 and a list of recently downloaded applications or recommended available applications from app store application 227. Similar widget content may be received from the other media applications 225-229. Application adapters 215-219 may receive the widget content and normalize it for use in widget 110, as described above.

At block 430, method 400 may store the received widget content in a local data store 230. Widget content storage module 213 may store the widget content received by widget synchronization module 214 in a database or other data structure in data store 230. In one embodiment, data store 230 may be a separate storage device designated for use by media widget process 210. In other embodiments, data store 230 may be part of a larger storage device (e.g., system memory of user device 102). In one embodiment, data store 230 may be a cache memory. Widget content storage module 213 may store or cache a copy of the received widget content in data store 230 so that it may be retrieved and used by widget 110 when needed, without having to fully launch the corresponding application from which the content was received.

At block 440, method 400 may display the stored widget content in a user interface of widget 110. Widget content delivery module 212 may request the stored widget content from data store 230 and publish it to media widget view interface 206. Media widget view interface 206 may display the widget content in a graphical or textual format. In one embodiment, media widget view interface 206 may accept user interaction with the widget content to, for example, show additional widget content, rearrange the widget content, select the widget content, view details of the widget content, or some other form of interaction. In one embodiment, the widget content may be constantly displayed in media widget view interface 206 in launcher 204 of operating system 202. In other embodiments, media widget view interface 206 may only display the widget content if the widget is specifically launched or selected by the user.

In some embodiments, as identified at block 450, method 400 may receive an indication of updated widget content from one or more of the underlying media applications 225-229. In one embodiment, the provider in each of media applications 225-229 may be configured to periodically (e.g., once a day, once an hour, etc.) send an indication of updated widget content to widget content synchronization module 214. In another embodiment, the providers may send the indication each time new updated widget content becomes available from the corresponding application. The updated widget content may have changes made to it as compared to the widget content previously received at block 420. In one embodiment, the received indication may include a description or identifier of the updated content, rather than the actual updated content itself.

In another embodiment, widget content synchronization module 214 may query the underlying applications 225-229 to determine if there is any updated widget content available. Widget content synchronization module 214 may send a request for updated widget content through the application adapters 215-219 periodically or in response to some event (e.g., launching of widget 110, a request from a user, etc.). In one embodiment, widget content synchronization module 214 may be configured to intelligently query the applications 225-229 based on the type of media content they provide. For example, if the widget content provided by e-reader application 229 includes a list of the most recent ebooks that the user has read, a synchronization schedule for e-reader application 229 may call for relatively infrequent updates. Since a typical ebook may take the user several days or weeks to finish reading, it may not be necessary to update the widget content from e-reader application 229 more than once a day, since it is unlikely to have changed since the last update. For another application, such as shopping application 228 where the widget content may include a list of certain goods that are currently on sale, the synchronization schedule may call for more frequent updates. The list of goods that are on sale may be changing very frequently, depending on factors such as availability, and thus it may be advantageous to update the widget content from shopping application 228 more often (e.g., once an hour). The synchronization schedules may be stored by media widget process 210 in data store 230 and may be configured by the widget developer, by the user, by the application developer, or by some other person or program.

In some instances, as indicated at block 460, method 400 determines if the updated widget content received at block 450 matches the widget content stored at block 430. Widget content synchronization module 214 may receive the indication of updated content from applications 225-229. Widget content synchronization module 214 may compare the updated content to previously stored widget content in data store 230. In one embodiment, widget content synchronization module 214 may compare the description or identifier of the updated content to a corresponding description or identifier of the content in data store 230. In another embodiment, widget content synchronization module 214 may perform a finger print analysis to determine if the updated content matches the stored content. In the fingerprint analysis a hash value formed from the updated content may be compared to an expected hash value (i.e., of the stored widget content). In other embodiments, some other comparison technique may be used. In one embodiment, two pieces of content may match if they are completely identical. In another embodiment, the pieces of content may match if they are substantially the same, partially the same, share some number of similar characteristics, etc.

If at block 460, method 400 determines that at least a portion the updated content does match the stored content, method 400 may return to block 440 and continue to display the stored widget content from data store 230 in media widget view interface 206. If the updated content matches the stored content it may mean that the indication of updated widget content received at block 450 was in error. In one embodiment, the updated widget content may be discarded. In another embodiment, the updated widget content may replace the stored widget content, even though they may be the same content.

If at block 460, method 400 determines that the updated content does not match the stored content, method 400 may proceed to block 470. In one embodiment, at block 470, method 400 may optionally synchronize the updated widget content and the stored widget content. In one embodiment, widget content storage module 213 may instruct widget content synchronization module 214 to request that the update widget content indicated in the indication received at block 450 be provided. The appropriate adapter of application adapters 215-219 may provide a URI to the provider of the corresponding application. In response, the application may send the updated widget content to widget content synchronization module 214. Widget content storage module 213 may store the updated content in data store 230. In one embodiment, the previously stored widget content for the corresponding application may be discarded. In another embodiment, the previously stored widget content may be maintained in data store 230 to serve as a log of past widget content. As a result of the synchronization, the updated widget content becomes the stored widget content, ensuring that the most current content is provided to the user of widget 110.

At block 480, method 400 displays the updated widget content to the user. Widget content storage module 213 may provide the updated content to widget content delivery module 212, which may publish that updated content as one or more view objects in media widget view interface 206. The updated widget content may be displayed on a display device (e.g., a touch screen) of user device 102.

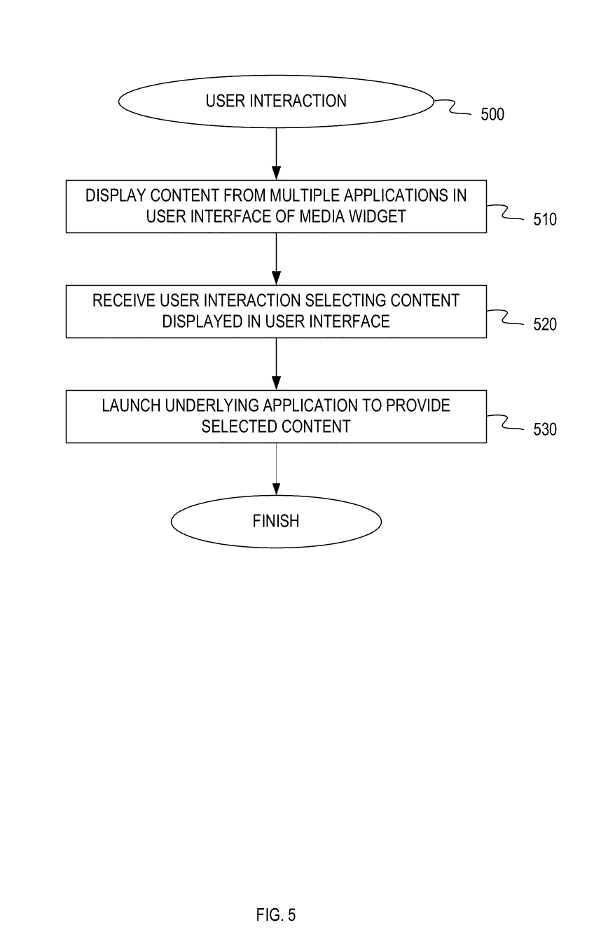

FIG. 5 is a flow diagram illustrating a user interaction method for a media widget, according to an embodiment of the present invention. The method 500 may be performed by processing logic that comprises hardware (e.g., circuitry, dedicated logic, programmable logic, microcode, etc.), software, firmware, or a combination thereof. The processing logic is configured to receive user interaction with a media widget that interfaces with multiple underlying applications. In one embodiment, method 500 may be performed by media widget process 210, as shown in FIG. 2.

Referring to FIG. 5, at block 510, method 500 displays content from multiple applications in a user interface of media widget 110. As discussed above, media widget process 210 may receive widget content from underlying applications 225-229 and display that widget content in media widget view interface 206.

At block 520, method 500 may receive a user interaction selecting an item from the widget content displayed in the user interface. In one embodiment, media widget view interface 206 may de displayed on a touch screen of user device 102. By interacting with the widget 110 through the touch screen, a user may select one or more items from the widget content that is displayed. For example, a user may select a recommended video clip provided by video application 226. Widget content delivery module 212 may receive the selection (e.g., through a touch screen controller (not shown)) and pass the selection down to widget content storage module 213. Widget content storage module 213 may identify the corresponding application (i.e., video application 226), for example, by accessing a database in data store 230. The database may maintain records associating each item of widget content with an underlying media application.

At block 530, method 500 may launch the underlying application to provide the selected media content to the user. Widget content storage module 213 may notify widget content synchronization module 214 of the user selection, and widget content synchronization module 214 may pass a request to the corresponding application.

In one embodiment, the request may be to launch the underlying application and play the selected widget content. In this example, widget content synchronization module 214 may launch video application 226 and request that video application 226 play the selected video clip.

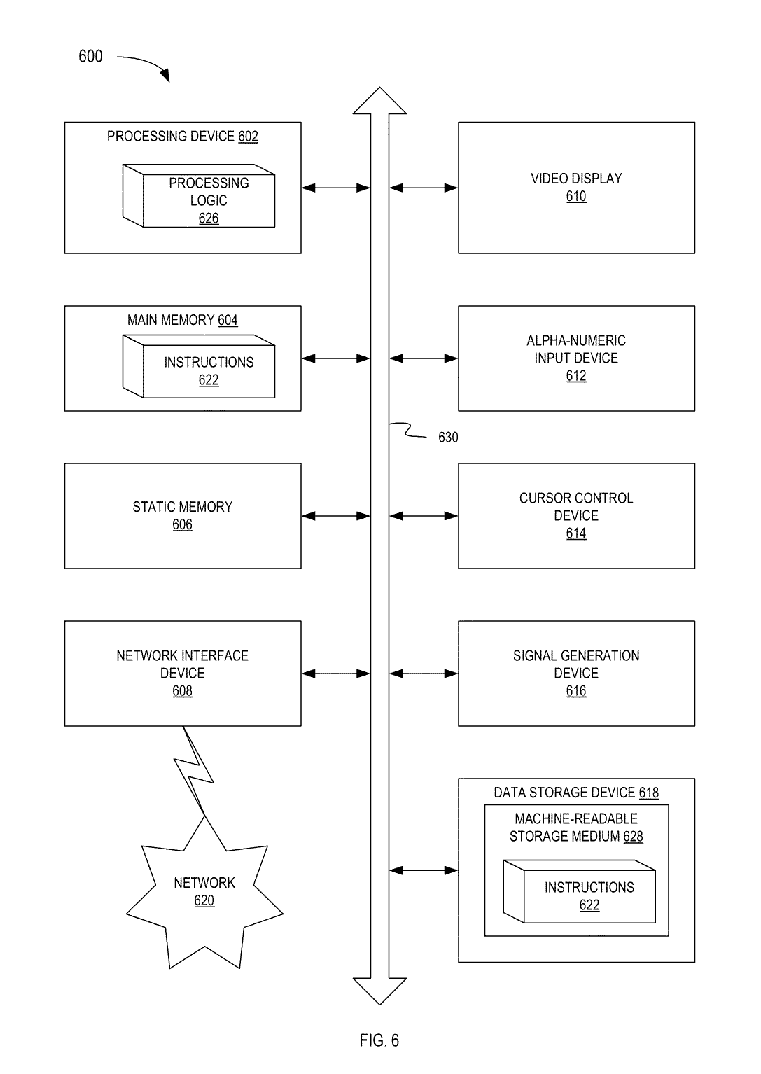

FIG. 6 illustrates a diagrammatic representation of a machine in the exemplary form of a computer system 600 within which a set of instructions, for causing the machine to perform any one or more of the methodologies discussed herein, may be executed. The system 600 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 600 may be representative of digital content providing system 120.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 618, which communicate with each other via a bus 630.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like.

The computer system 600 may further include a network interface device 608. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The data storage device 618 may include a computer-readable medium 628 on which is stored one or more sets of instructions 622 (e.g., instructions of language classification module 127) embodying any one or more of the methodologies or functions described herein. The instructions 622 may also reside, completely or at least partially, within the main memory 604 and/or within processing logic 626 of the processor 602 during execution thereof by the computer system 600, the main memory 604 and the processor 602 also constituting computer-readable media. The instructions may further be transmitted or received over a network 620 via the network interface device 608.

While the computer-readable storage medium 628 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

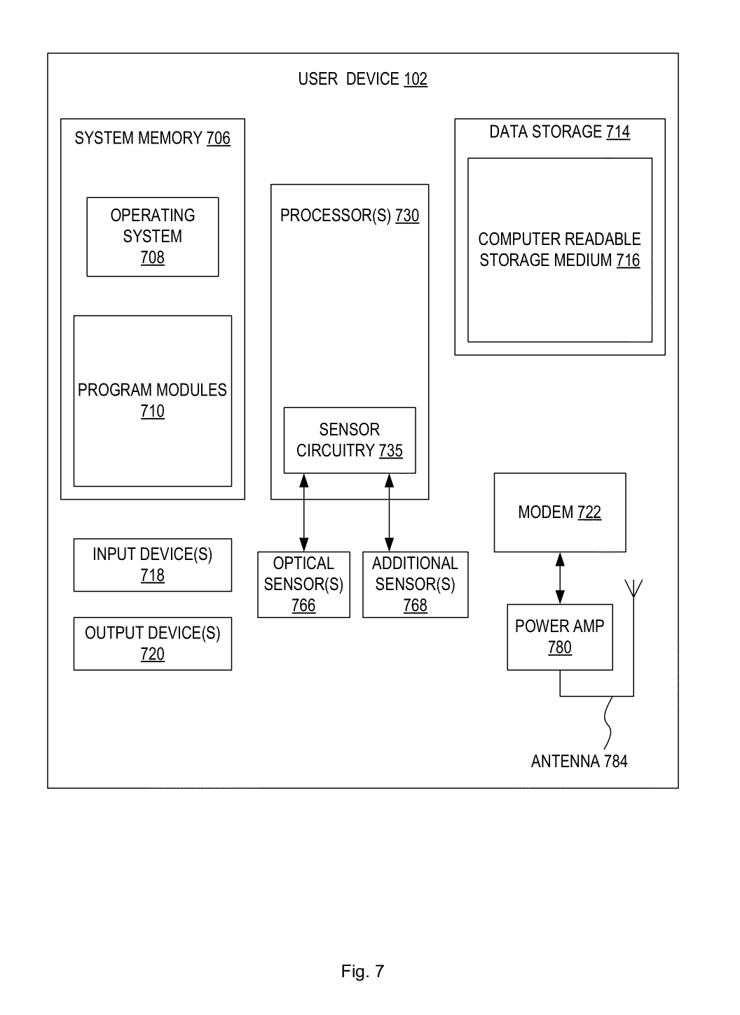

FIG. 7 is a block diagram illustrating an exemplary user device 102. In one embodiment, the user device 102 may correspond to one or all of the user devices 102, 104 of FIG. 1 and may be any type of user device such as an electronic book reader, a PDA, a mobile phone, a laptop computer, a portable media player, a tablet computer, an electronic pad, a desktop computer, a camera, a video camera, a netbook, and the like.

The user device 102 includes one or more processing devices or processors 730, such as one or more CPUs, microcontrollers, field programmable gate arrays, or other types of processing devices. The user device 102 also includes system memory 706, which may correspond to any combination of volatile and/or non-volatile storage mechanisms. The system memory 706 stores information which provides an operating system component 708, various program modules 710 and/or other components. The user device 102 performs functions by using the processor(s) 730 to execute instructions provided by the system memory 706.

The user device 102 also includes a data storage device 714 that may be composed of one or more types of removable storage and/or one or more types of non-removable storage. The data storage device 714 includes a computer-readable storage medium 716 on which is stored one or more sets of instructions embodying any one or more of the methodologies or functions described herein. As shown, instructions may reside, completely or at least partially, within the computer readable storage medium 716, system memory 706 and/or within the processor(s) 730 during execution thereof by the user device 102, the system memory 706 and the processor(s) 730 also constituting computer-readable media. The user device 102 may also include one or more input devices 718 (keyboard, mouse device, specialized selection keys, etc.) and one or more output devices 720 (displays, printers, audio output mechanisms, etc.).

The user device 102 further includes a wireless modem 722 to allow the user device 102 to communicate via a wireless network (e.g., such as provided by the wireless communication system) and/or with other computing devices, such as remote computers, the item providing system, online book stores, electronic catalogs for libraries, and so forth. The wireless modem 722 may allow the user device 102 to handle both voice and non-voice communications (such as communications for text messages, media messages, media downloads, web browsing, etc.) with the wireless communication system 110. The wireless modem 722 may provide network connectivity using any type of mobile network technology including, for example, cellular digital packet data (CDPD), general packet radio service (GPRS), enhanced data rates for GSM evolution (EDGE), universal mobile telecommunications system (UMTS), 1 times radio transmission technology (1×RTT), evaluation data optimized (EVDO), high-speed downlink packet access (HSDPA), WiFi, etc. The wireless modem 722 may generate signals and send these signals to power amplifier (amp) 780 for amplification, after which they are wirelessly transmitted via antenna 784. In addition to sending data, antenna 784 also receives data, which is sent to wireless modem 722 and transferred to processor(s) 730.

In one embodiment, user device 102 includes an optical sensor 766. The optical sensor 766 may be a low resolution camera (e.g., having 0.2 or 0.3 Megapixels) that takes images (e.g., of a user's eyes) on a periodic basis. Alternatively, the optical sensor 766 may have a higher resolution, such as 1 Megapixel up to 10 or more Megapixels. The optical sensor 766 may be positioned such that images are taken of a user's face while the user holds the user device 102 in front of his face in a standard reading position. Therefore, the optical sensor 766 may be used to track user eye movement during reading.

In one embodiment, user device 102 includes one or more additional sensors 768 such as a physical contact sensor, close proximity sensors, or motion sensors. The sensors 768 can detect the presence of human body parts, and convey information regarding the detected presence to processor(s) 730. In one embodiment, the sensors 768 may be capacitive sensors that are configured to measure capacitance generated by the presence of the human body part using any one of various techniques known in the art, for example, relaxation oscillation, a current verses voltage phase shift comparison, resistor-capacitor charge timing, capacitive bridge division, charge transfer, sigma-delta modulation, or charge-accumulation. In an alternative embodiment, the sensors 768 may also be optical (e.g., infrared) sensors that use an emitter and receiver pair to detect the presence of opaque objects. Alternatively, the sensors 768 may be inductive sensors, which include an inductive loop. When the presence of a human body part (or metal object) is brought close to the inductive sensor, an induction of the inductive loop changes, causing the human body part to be detected. Alternatively, the sensors 768 may be ultrasonic sensors that emit an ultrasonic signal and measure a time duration between when a signal is transmitted and the reflection of that signal received (a.k.a., flight response). The sensors 768 may also include other types of sensors, such as those that operate using the detection principles of resistive (e.g., analog resistive, digital resistive or residual resistive), surface acoustic wave, electromagnetic, near field imaging, or other technologies. In one embodiment, multiple different types of sensors are used. Though the detected object is described herein as a human body part, other types of objects may also be detected depending on the sensing technologies used.

In one embodiment, the additional sensors 768 include a motion sensor, such as an accelerometer or one or more gyroscopes. The user device 102 may use motion data from motion sensors to determine whether a user is holding the user device 102. For example, if the user device 102 experiences constant minor accelerations, it may be determined that the user device 102 is being held in a user's hand. Additionally, if the user device 102 is at a particular angle (detectable based on acceleration readings from an accelerometer), it may be determined that the user device 102 is being rested on a user's leg during reading.

The processor(s) 730 may include sensor circuitry 735 (e.g., sensor device drivers) that enables the processor(s) 730 to interpret signals received from the optical sensor(s) 766 and/or additional sensors 768. In one embodiment, the optical sensors 766 and/or additional sensors 768 output raw sensor data. In another embodiment, the optical sensors 766 and/or additional sensors 768 output fully processed signals to the processor(s) 730. For example, the additional sensors 768 may output a user contact/no user contact signal using a single line interface or a multi-line interface. In another embodiment, the additional sensors 768 output, for example, positional data and/or object presence data (e.g., of a human body part) to the processors 730 without first processing the data. In either instance, the processors 730 may use the sensor circuitry 735 to process and/or interpret the received data. If data is received from multiple sensors, processing the data may include averaging the data, identifying a maximum from the data, or otherwise combining the data from the multiple sensors.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “identifying”, “adding”, “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A user device comprising:
a processor; and
a memory coupled to the processor, the memory storing:
at least one of a plurality of media applications; and
a media widget process, executable by the processor, the media widget process comprising:
a widget content synchronization module comprising a plurality of application adapters, each of the plurality of application adapters configured to interface with a different one of the plurality of media applications configured to provide media content;
a widget content storage module configured to store, in the memory, widget content received by the plurality of application adapters from the plurality of media applications, the widget content corresponding to the media content; and
a widget content delivery module configured to provide a user interface to display the widget content stored in the memory.

2. The user device of claim 1, wherein the plurality of media applications comprises at least two different types of media applications selected from the following application types: an audio application; a video application; a mobile application store; a shopping application; or an electronic reader application.

3. The user device of claim 1, wherein the user interface is displayed in conjunction with a display of a home screen of an operating system running on the user device.

4. The user device of claim 1, wherein the widget content delivery module is further configured to receive a user interaction selecting an item from the widget content displayed in the user interface and configured to launch a media application of the plurality of media applications to provide media content for the selected item.

5. The user device of claim 1, wherein the widget content synchronization module is further configured to receive at least a portion of the widget content from the plurality of media applications.

6. The user device of claim 1, wherein
the widget content synchronization module is further configured to receive an indication of updated widget content from one of the plurality of media applications, and
the widget content synchronization module is further configured to determine if the updated widget content matches at least a portion of the widget content stored in the memory.

7. The user device of claim 6, wherein
if the updated widget content does not match the widget content stored in the memory, the widget content synchronization module further to synchronize the updated widget content and the widget content stored in the memory, and the widget content delivery module further to display the updated widget content in the user interface; and
if the updated widget content does match at least a portion of the widget content stored in the memory, the widget content delivery module further to continue to display the widget content stored in the memory.

8. A method comprising:
establishing an operational connection between a media widget and a plurality of underlying media applications on a user device, the plurality of underlying media applications configured to provide media content; and
providing, by a processor, widget content from at least one of the plurality of underlying media applications through the operational connection to the media widget, the widget content corresponding to the media content.

9. The method of claim 8, wherein the media widget comprises a media widget user interface and a media widget process.

10. The method of claim 9, further comprising:
receiving, by the media widget user interface, a user interaction selecting an item from the widget content; and
launching, by the media widget process, an underlying media application, of the plurality of underlying media applications, to provide media content corresponding to the selected item from the widget content.

11. The method of claim 9, further comprising:
receiving, by the media widget process, at least of portion of the widget content from the plurality of underlying media applications; and
storing, by the media widget process, the widget content in a local data store.

12. The method of claim 9, further comprising:
displaying, by the media widget user interface, the widget content.

13. The method of claim 9, further comprising:
receiving, by the media widget process, an indication of updated widget content from one of the plurality of underlying media applications; and
determining, by the media widget process, if the updated widget content matches at least a portion of the widget content stored in the local data store.

14. The method of claim 13, further comprising:
if the updated widget content does not match the widget content stored in the local data store, synchronizing, using the media widget process, the updated widget content and the widget content stored in the local data store and displaying, using the media widget user interface, the updated widget content to the user; and
if the updated widget content does match at least a portion of the widget content stored in the local data store, continuing to display, by the media widget user interface, the widget content stored in the local data store.

15. A non-transitory computer-readable storage medium storing instructions which, when executed, cause a processor to perform a method comprising:
providing a media widget, the media widget configured to interface with a plurality of underlying media applications on a user device, the plurality of underlying media applications configured to provide media content;
receiving an indication of updated widget content from one of the plurality of underlying media applications, the widget content corresponding to the media content;
synchronizing widget content stored by the media widget with the updated widget content from the one of the plurality of underlying media applications; and
displaying the updated widget content in a user interface of the media widget.

16. The non-transitory computer-readable storage medium of claim 15, wherein the plurality of media applications comprises at least two different types of media applications selected from the following application types: an audio application; a video application; a mobile application store; a shopping application; or an electronic reader application.

17. The non-transitory computer-readable storage medium of claim 15, wherein the user interface is displayed in conjunction with a display of a home screen of an operating system running on the user device.

18. The non-transitory computer-readable storage medium of claim 15, wherein the media widget comprises the user interface and a media widget process.

19. The non-transitory computer-readable storage medium of claim 18, the method further comprising:
receiving, by the user interface, a user interaction selecting an item from the widget content; and
launching, by the media widget process, an underlying media application, of the plurality of underlying media applications, to provide media content corresponding to the selected item from the widget content.

20. The non-transitory computer-readable storage medium of claim 18, the method further comprising:
receiving, by the media widget process, the widget content from at least one of the plurality of underlying media applications; and
storing, by the media widget process, the widget content in a local data store.

21. The non-transitory computer-readable storage medium of claim 20, the method further comprising:
determining, by the media widget process, if the updated widget content matches at least a portion of the widget content stored in the local data store.

22. The non-transitory computer-readable storage medium of claim 21, the method further comprising:
if the updated widget content does not match the widget content stored in the local data store, synchronizing, by the media widget process, the widget content stored in the local data store with the updated widget content; and
if the updated widget content does match at least a portion of the widget content stored in the local data store, displaying, by the user interface, the widget content stored in the local data store.

23. The non-transitory computer-readable storage medium of claim 15, further storing one or more of the plurality of underlying media applications.
